(19) United States
(12) Patent Application Publication
(10) Pub. No.: US 2009/0218327 A1
(43) Pub. Date: Sep. 3, 2009

(54) HYDRAULICALLY DRIVEN TOOL SYSTEM

(75) Inventor: Richard Beeson, Appleton, WI (US)

Correspondence Address: FLETCHER YODER (ILLINOIS TOOL WORKS INC.), P.O. BOX 692289, HOUSTON, TX, 77269-2289, US

(73) Assignee: ILLINOIS TOOL WORKS INC., Glenview, IL (US)

(21) Appl. No.: 12/040,328

(22) Filed: Feb. 29, 2008

(51) Int. Cl. B23K 9/10; F04B 17/05; F04B 17/00

(52) U.S. Cl. 219/133; 417/364; 417/375

(57) ABSTRACT

A system, in one embodiment, includes a first service pack module and a second service pack module, wherein the first and second service pack modules are separate from one another. The first service pack module includes a hydraulic motor, an air compressor drivingly coupled to the hydraulic motor, and a generator drivingly coupled to the hydraulic motor. The second service pack module includes an engine, and a hydraulic pump drivingly coupled to the engine. The hydraulic pump also may be configured to supply hydraulic fluid to the hydraulic motor of the first service pack module. A system, in another embodiment, includes a first enclosure, a hydraulic motor, an air compressor drivingly coupled to the hydraulic motor, and a generator drivingly coupled to the hydraulic motor, wherein the hydraulic motor, the air compressor, and the generator are self-contained within the first enclosure without an engine and a hydraulic pump.

### BACKGROUND

The present invention relates generally to work vehicles, and more particularly to arrangements for providing auxiliary support systems in such work vehicles. More particularly, the invention relates to a flexible arrangement for providing electrical power, compressed air service, and/or hydraulic service in a work vehicle.

Existing work vehicles often integrate auxiliary resources, such as electrical power, compressed air service, and/or hydraulic service, directly to the mechanical power of the main vehicle engine. Specifically, the main vehicle engine may drive a power take-off shaft, which in turn drives the various integrated auxiliary resources. This is common in many applications where the auxiliary systems are provided as original equipment, either standard with the vehicle or as an option. The work vehicles also may include a clutch or other selective engagement mechanism to enable the selective engagement and disengagement of the integrated auxiliary resources.

Unfortunately, these integrated auxiliary resources rely on operation of the main vehicle engine. The main vehicle engine is typically a large engine, which is particularly noisy, significantly over powered for the integrated auxiliary resources, and fuel inefficient. For example, the main vehicle engine may be a spark ignition engine or a compression ignition engine (e.g., diesel engine) having 8, 10, or 12 cylinders. The main vehicle engine may have over 200 horsepower, while the integrated auxiliary resources may only need about 20-40 horsepower. Unfortunately, an operator typically leaves the main vehicle engine idling for extended periods between actual use of the integrated auxiliary resources, simply to maintain the option of using the resources without troubling the operator to start and stop the main vehicle engine. Such operation reduces the overall life of the engine and drive train for vehicle transport needs.

### BRIEF DESCRIPTION

A system, in one embodiment, includes a first service pack module and a second service pack module, wherein the first and second service pack modules are separate from one another. The first service pack module includes a hydraulic motor, an air compressor drivingly coupled to the hydraulic motor, and a generator drivingly coupled to the hydraulic motor. The second service pack module includes an engine, and a hydraulic pump drivingly coupled to the engine. The hydraulic pump also may be configured to supply hydraulic fluid to the hydraulic motor of the first service pack module. A system, in another embodiment, includes a first enclosure, a hydraulic motor, an air compressor drivingly coupled to the hydraulic motor, and a generator drivingly coupled to the hydraulic motor, wherein the hydraulic motor, the air compressor, and the generator are self-contained within the first enclosure without an engine and a hydraulic pump.

### DRAWINGS

These and other features, aspects, and advantages of the present invention will become better understood when the following detailed description is read with reference to the accompanying drawings in which like characters represent like parts throughout the drawings, wherein:

FIG. 1 is a diagram illustrating a work vehicle having first and second service pack modules in accordance with embodiments of the present technique;

FIG. 2 is diagram illustrating first and second service pack modules in hydraulic communication with one another in accordance with embodiments of the present technique;

FIG. 3 is a diagram illustrating first and second control panels of the respective first and service pack modules as illustrated in FIG. 2, in accordance with embodiments of the present technique;

FIG. 4 is diagram illustrating first and second service pack modules in hydraulic communication with one another, wherein a fuel tank is external to the service pack modules (i.e., not part of the modules) in accordance with embodiments of the present technique;

FIG. 5 is a diagram illustrating an embodiment of the first service pack module as illustrated in FIGS. 1-4;

FIG. 6 is a diagram illustrating an embodiment of the second service pack module as illustrated in FIGS. 1-4; and

FIG. 7 is a diagram illustrating a work vehicle having the first service pack module as illustrated in FIGS. 1-5 in accordance with embodiments of the present technique.

### DETAILED DESCRIPTION

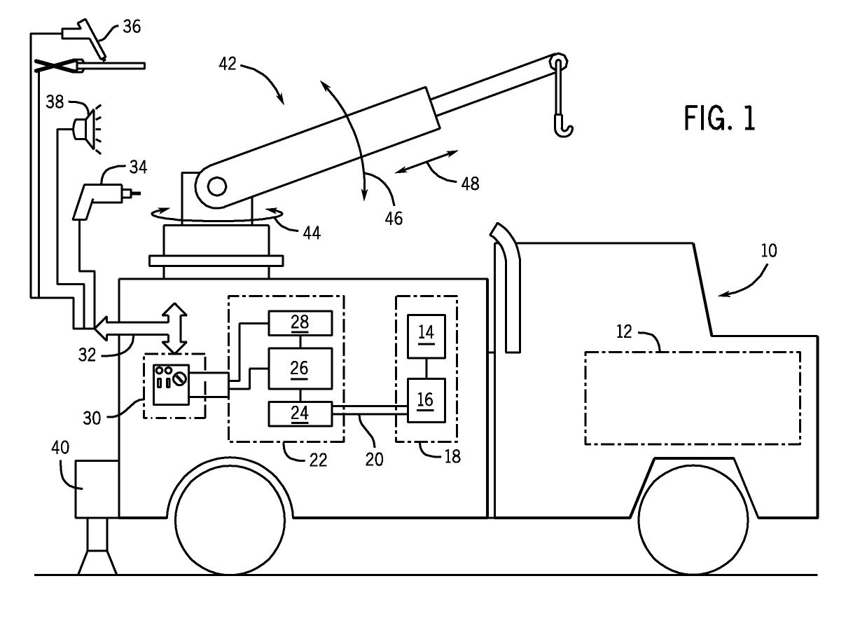

Turning now to the drawings, FIG. 1 illustrates a work vehicle 10 including a main vehicle engine 12, first and second service pack modules 18 and 22, and various equipment in accordance with certain embodiments of the present technique. As discussed in further detail below, the first and second service pack modules 18 and 22 may provide various resources, such as electrical power, compressed air, and hydraulic power, with or without assistance from the main vehicle engine 12. Thus, in some embodiments, the operator can shut off the main vehicle engine to reduce noise, conserve fuel, and increase the life of the main vehicle engine 12, while the service pack modules 18 and 22 are self-powered or power one another. However, in some embodiments, the service pack modules 18 and 22 may utilize and/or provide some resources of the vehicle 10, e.g., use fuel from the vehicle, use hydraulic power from the vehicle, provide hydraulic power to the vehicle, and so forth. The illustrated work vehicle 10 is a work truck, yet other embodiments of the vehicle may include other types and configurations of vehicles.

The main vehicle engine 12 may include a spark ignition engine (e.g., gasoline fueled internal combustion engine) or a compression ignition engine (e.g., a diesel fueled engine), for example, an engine with 8, 10, or 12 cylinders with over 200 horsepower. The vehicle engine 12 includes a number of support systems. For example, the vehicle engine 12 consumes fuel from a fuel reservoir, typically one or more liquid fuel tanks, which will be addressed later. Further, the vehicle engine 12 may include or couple to an engine cooling system, which may include a radiator, circulation pump, thermostat controlled valve, and a fan. The vehicle engine 12 also includes an electrical system, which may include an alternator or generator along with one or more system batteries, cable assemblies routing power to a fuse box or other distribution system, and so forth. The vehicle engine 12 also includes an oil lubrication system. Further, the vehicle engine 12 also couples to an exhaust system, which may include catalytic converters, mufflers, and associated conduits. Finally, the vehicle engine may feature an air intake system, which may include filters, flow measurement devices, and associated conduits.

The service pack modules 18 and 22 may have a variety of resources, such as electrical power, compressed air, hydraulic power, and so forth. These service pack modules 18 and 22 also may operate alone or in combination with one another, e.g., dependent on one another. In the illustrated embodiment, the first service pack module 18 includes a service pack engine 14 and a hydraulic pump 16. The service pack engine 14 may include a spark ignition engine (e.g., gasoline fueled internal combustion engine) or a compression ignition engine (e.g., a diesel fueled engine), for example, an engine with 1-4 cylinders with 10-80 horsepower. The hydraulic pump 16 is configured to provide hydraulic power (e.g., pressurized hydraulic fluid) to one or more devices in the vehicle or elsewhere. The hydraulic pump 16 may be based on any suitable technology, such as piston pumps, gear pumps, vane pumps, with or without closed loop control of pressure and/or flow.

As illustrated in the embodiment of FIG. 1, the first and second service pack modules 18 and 22 are separate from one another and from vehicle engine 12. In other words, the first and second service pack modules 18 and 22 are stand-alone units relative to the vehicle engine 12, such that they do not rely on power from the vehicle engine 12. However, in the illustrated embodiment, the second service pack module 22 is driven by hydraulic fluid from the first service pack module 18, thereby making the second service pack module 22 dependent on the first service pack module 18 or another source of hydraulic fluid. Specifically, as illustrated in FIG. 1, the service pack engine 14 drives a hydraulic pump 16, which in turn drives hydraulic motor 24 located in second service pack module 22.

The hydraulic motor 24 contained in second service pack module 22 may be coupled to air compressor 26 as well as generator 28. The air compressor 26 and the generator 28 may be driven directly, or may be belt, gear, or chain driven, by the hydraulic motor 24. The generator 28 may include a three-phase brushless type, capable of producing power for a wide range of applications. However, other generators may be employed, including single phase generators and generators capable of producing multiple power outputs. The air compressor 26 may also be of any suitable type, although a rotary screw air compressor is presently contemplated due to its superior output to size ratio. Other suitable air compressors might include reciprocating compressors, typically based upon one or more reciprocating pistons.

The first and/or second service pack modules 18 and 22 include conduits, wiring, tubing, and so forth for conveying the services/resources (e.g., electrical power, compressed air, and hydraulic power) generated by these modules to an access panel 30. The access panel 30 may be located on any portion of the vehicle 10, or on multiple locations in the vehicle, and may be covered by doors or other protective structures. In one embodiment, all of the services may be routed to a single/common access panel 30. The access panel 30 may include various control inputs, indicators, displays, electrical outputs, pneumatic outputs, and so forth. In an embodiment, a user input may include a knob or button configured for a mode of operation, an output level or type, etc. In the illustrated embodiment, the first and second service pack modules 18 and 22 supply electrical power, compressed air, and hydraulic power to a range of applications designated generally by arrows 32.

As depicted, air tool 34, torch 36, and light 38 are applications connected to the access panel 30 and, thus, the resources/services provided by the service pack modules 18 and 22. The various tools may connect with the access panel 30 via electrical cables, gas (e.g., air) conduits, and so forth. The air tool 34 may include a pneumatically driven wrench, drill, spray gun, or other types of air-based tools, which receive compressed air from the access panel 30 and compressor 26 via a supply conduit (e.g., a flexible rubber hose). The torch 36 may utilize electrical power and compressed gas (e.g., air or inert shielding gas) depending on the particular type and configuration of the torch 36. For example, the torch 36 may include a welding torch, a cutting torch, a ground cable, and so forth. More specifically, the welding torch 36 may include a TIG (tungsten inert gas) torch or a MIG (metal inert gas) gun. The cutting torch 36 may include a plasma cutting torch and/or an induction heating circuit. Moreover, a welding wire feeder may receive electrical power from the access panel 30. Moreover, a hydraulically powered vehicle stabilizer 40 may be powered by the hydraulic system, e.g., hydraulic pump 16, to stabilize the work vehicle 10 at a work site. In the illustration, a hydraulically powered crane 42 is also coupled to and powered by the hydraulic pump 16. Again, the service pack modules 18 and 22 provide the desired resources/services to run various tools and equipment without requiring operation of the main vehicle engine 12.

As noted above, the disclosed service pack modules 18 and 22 may be designed to interface with any desired type of vehicle. Such vehicles may include cranes, manlifts, and so forth, which can be powered by the service pack modules 18 and/or 22. In the embodiment of FIG. 1, the crane 42 may be mounted within a bed of the vehicle 10, on a work platform of the vehicle 10, or on an upper support structure of the vehicle 10 as shown in FIG. 1. Moreover, such cranes may be mechanical, electrical or hydraulically powered. In the illustrated embodiment, the crane 42 can be powered by the service pack modules 18 and/or 22 without relying on the vehicle engine 12. That is, once the vehicle is positioned at the work site, the vehicle engine 12 may be stopped and the service pack engine 14 may be started for crane operation and use of auxiliary services. In the embodiment illustrated in FIG. 1, the crane 42 is mounted on a rotating support structure, and hydraulically powered such that it may be rotated, raised and lowered, and extended (as indicated by arrows 44, 46 and 48, respectively) by pressurized hydraulic fluid provided by the service pack output 32.

The vehicle 10 and/or the service pack modules 18 and 22 may include a variety of protective circuits for the electrical power, e.g., fuses, circuit breakers, and so forth, as well as valving for the hydraulic and air service. For the supply of electrical power, certain types of power may be conditioned (e.g., smoothed, filtered, etc.), and 12 volt power output may be provided by rectification, filtering and regulating of AC output. Valving for hydraulic power output may include by way example, pressure relief valves, check valves, shut-off valves, as well as directional control valving. Moreover, the hydraulic pump 16 may draw fluid from and return fluid to a fluid reservoir, which may include an appropriate vent for the exchange of air during use with the interior volume of the reservoir, as well as a strainer or filter for the hydraulic fluid. Similarly, the air compressor 26 may draw air from the environment through an air filter.

The first and second service pack modules 18 and 22 may be physically positioned at any suitable location in the vehicle 10. In a presently contemplated embodiment, for example, the service pack modules 18 and 22 may be mounted on, beneath or beside the vehicle bed or work platform rear of the vehicle cab. In many such vehicles, for example, the vehicle chassis may provide convenient mechanical support for the engine and certain of the other components of the service pack modules 18 and 22. For example, steel tubing, rails or other support structures extending between front and rear axles of the vehicle may serve as a support for the service pack modules 18 and 22 and, specifically, the components self-contained in those modules. Depending upon the system components selected and the placement of the service pack modules 18 and 22, reservoirs may be provided for storing hydraulic fluid and pressurized air as noted above. However, the hydraulic reservoir may be placed at various locations or even integrated into the service pack modules 18 and/or 22. Likewise, depending upon the air compressor selected, no reservoir may be used for compressed air. Specifically, if the air compressor 26 includes a non-reciprocating or rotary type compressor, then the system may be tankless with regard to the compressed air.

In use, the service pack modules 18 and 22 provide various resources/services (e.g., electrical power, compressed air, hydraulic power, etc.) for the on-site applications completely independent of vehicle engine 12. For example, the service pack engine 14 generally may not be powered during transit of the vehicle from one service location to another, or from a service garage or facility to a service site. Once located at the service site, the vehicle 10 may be parked at a convenient location, and the main vehicle engine 12 may be shut down. The service pack engine 14 may then be powered to provide auxiliary service from one or more of the service systems described above. Where desired, clutches, gears, or other mechanical engagement devices may be provided for engagement and disengagement of one or more of the generator 28, the hydraulic pump 16, and the air compressor 26, depending upon which of these service are desired. Moreover, as in conventional vehicles, where stabilization of the vehicle or any of the systems is require, the vehicle may include outriggers, stabilizers, and so forth which may be deployed after parking the vehicle and prior to operation of the service pack modules. The disclosed embodiments thus allow for a service to be provided in several different manners and by several different systems without the need to operate the main vehicle engine 12 at a service site.

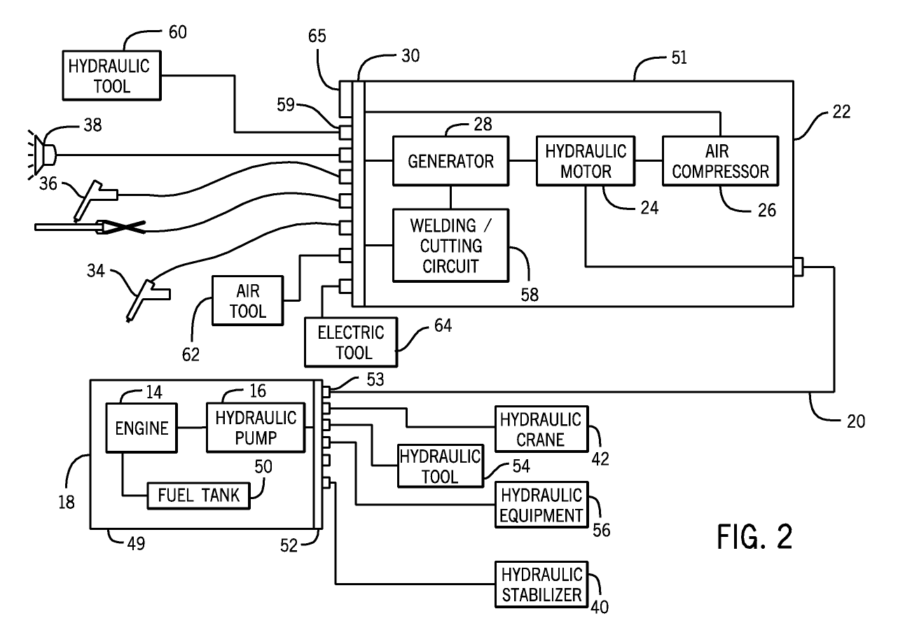

Several different arrangements are envisaged for the components of the first service pack module 18 and the second service pack module 22. FIG. 2 illustrates an embodiment of the first and second service pack modules 18 and 22, wherein the first service pack module 18 includes the service pack engine 14, the hydraulic pump 16, and a fuel tank 50, and wherein the second service pack module 22 includes the hydraulic motor 24, the air compressor 26, and the generator 28. As discussed below, the components of each service pack modules 18 and 22 are self-contained in respective enclosures 49 and 51, such that the modules 18 and 22 are independent and distinct from one another. In other words, the enclosure 49 of the module 18 self contains the engine 14, the hydraulic pump 16, and the fuel tank 50 independent of both the module 22 and various components of the vehicle 10. Similarly, the enclosure 51 of the module 22 self contains the hydraulic motor 24, the air compressor 26, and the generator 28 independent of both the module 18 and various components of the vehicle 10.

In some embodiments, each module 18 and 22 may be described as consisting essentially of the components shown in FIG. 2. For example, the first service pack module 18 may be described as consisting essentially of the enclosure 49, the engine 14 within the enclosure 49, the hydraulic pump 16 within the enclosure 49, and the fuel tank 50 within the enclosure 49. Thus, the first service pack module 18 may be described as not including one or more of the components provided in the second service pack module 22 (e.g., the hydraulic motor 24, the air compressor 26, and/or the generator 28). By further example, the second service pack module 22 may be described as consisting essentially of the enclosure 51, the hydraulic motor 24 within the enclosure 51, the air compressor 26 within the enclosure 51, and the generator 28 within the enclosure 51. However, in the illustrated embodiment of FIG. 2, the second service pack module 22 may be described as consisting essentially of the enclosure 51, the hydraulic motor 24 within the enclosure 51, the air compressor 26 within the enclosure 51, the generator 28 within the enclosure 51, and also a welding/cutting circuit 58 within the enclosure 51. Thus, the second service pack module 22 may be described as not including one or more of the components provided in the first service pack module 18 (e.g., engine 14, the hydraulic pump 16, and/or the fuel tank 50). Specifically, in the embodiment shown in FIG. 2, the second service pack module 22 does not include an engine (e.g., a fuel-powered engine) and a hydraulic pump.

Moreover, the service pack modules 18 and 22 may be used independently or in combination with one another. For example, the first service pack module 18 may be used to provide hydraulic power for any type of hydraulically driven system, which may or may not include the second service pack module 22. In certain embodiments, the first service pack module 18 may be described as dependent only on a source of fuel, such as gasoline or diesel fuel, to operate the engine 14 and provide the hydraulic power. By further example, the second service pack module 22 may be hydraulically driven by any suitable source of hydraulic power, which may or may not include the hydraulic pump 16 of the first service pack module 18. Thus, in certain embodiments, the second service pack module 22 may be described as hydraulically dependent on some source of hydraulic power, or more specifically, only hydraulic power dependence.

As appreciated, the separation of these various components (e.g., 14, 16, 24, 26, 28, 50, and 50) into multiple stand-alone modules (e.g., 18 and 22) enables a more flexible use of these services/resources in various applications. For example, if the application already has a source of hydraulic power, then the second service pack module 22 is particularly useful without the need for the first service pack module 18. Similarly, if the application already has a source of electrical power and/or compressed air but no source of hydraulic power, then the first service pack module 18 is particularly useful without the need for the second service pack module 18. In contrast, if a single unit incorporated all of the components (e.g., 14, 16, 24, 26, 28, 50, and 50), then the application may end up with redundant resources. As a result, the separation of the components (e.g., 14, 16, 24, 26, 28, 50, and 50) into the modules 18 and 22 not only provides for a more flexible approach, but it also reduces the cost, size, weight, and complexity of each individual module 18 and 22.

Turning now to the details of FIG. 2, the first service pack module 18 includes a first service access panel 52, which includes hydraulic couplings 53 to output hydraulic fluid from the hydraulic pump 16 to various external devices. In the illustrated embodiment, the hydraulic couplings 53 couple to the second service pack module 22, the hydraulic crane 42, a hydraulic tool 54, hydraulic equipment 56, and the hydraulic stabilizer 40. For example, the second service pack module 22 is connected to the first service pack module 18 via hydraulic tubing 20 connected to one of the couplings 53.

As further illustrated in FIG. 2, the second service pack module 22 includes the hydraulic motor 24 coupled to the air compressor 26 and generator 28, which is connected to the welding/cutting circuit 58. The circuit 58 may include one or more circuits configured to provide power, functions, and control for welding, cutting, wire feeding, gas supply, and so forth. The generator 28 may provide electrical power to the welding circuit 58 to operate various welding devices, such as those discussed above. The second service pack module 22 also includes a service pack access panel (e.g., 30), which includes couplings 59 (e.g., electrical, air, and optionally hydraulic connectors) for various external devices. For example, the service pack module 22 may or may not provide hydraulic couplings 59 as a pass through from the hydraulic fluid received into the system. Connections to access panel 30 may provide service to several tools, including hydraulic tool 60, air tool 62, electric tool 64, air tool (e.g., wrench) 34, torch 36, and light 38. In addition, the various external devices include electrical cables, air hoses, hydraulic tubing, and so forth, as illustrated by the lines extending between the devices and their respective couplings 59 on the panel 30. The access panel 30 also may include one or more controls 65 for the various services/resources, e.g., electrical power, compressed air, hydraulics, etc. As discussed below, these controls 65 may include input controls (e.g., switches, selectors, keypads, etc.) and output displays, gauges, and the like.

As appreciated, the generator 28 and/or circuit 58 may be configured to provide AC power, DC power, or both, for various applications. Moreover, the circuit 58 may function to provide constant current or constant voltage regulated power suitable for a welding or cutting application. Thus, the torch 36 may be a welding torch 36, such as a MIG welding torch, a TIG welding torch, and so forth. The torch 36 also may be a cutting torch, such as a plasma cutting torch. The generator 28 and/or circuit 58 also may provide a variety of output voltages and currents suitable for different applications. For example, a 12 volt DC output of the module 22 may also serve to maintain the vehicle battery charge, and to power any ancillary loads that the operator may need during work (e.g., cab lights, hydraulic system controls, etc.).

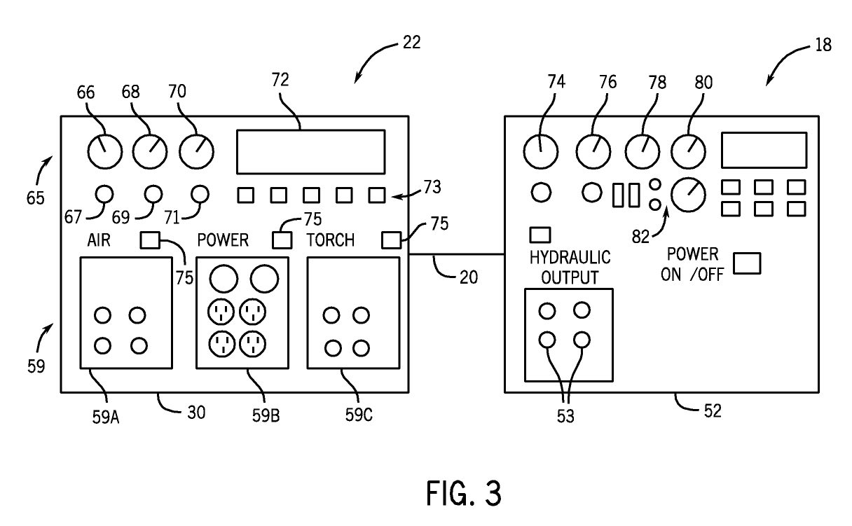

FIG. 3 illustrates an embodiment of the access panels 30 and 52 of the respective first and second service pack modules 18 and 22, as shown in FIGS. 1 and 2. In the illustrated embodiment, the access panel 30 of the module 22 includes the various couplings 59 and controls 65 shown in FIG. 2. Specifically, the couplings include a set of air couplings 59A, a set of electrical power couplings 59B, and a set of torch couplings 59C. The controls 65 include a voltage gauge 66 and associated voltage control knob 67, a current gauge 68 and associated current control knob 69, an air pressure gauge 70 and associated pressure control knob 71, and a display screen 72 (e.g., liquid crystal display) and associated input keys 73. The controls 65 also may include on/off switches or buttons 75 for each of the couplings 59, such that an operator can turn on and off the electrical power, the compressed air, and/or the hydraulic power linked to the couplings 59A, 59B, and 59C. Optionally, the access panel 30 may include various hydraulic couplings, gauges, and controls in an embodiment that routes at least some of the hydraulic fluid from the first module 18 through the second module 22 to various external hydraulic devices. Furthermore, the access panel 30 may be used as a central control panel for all resources/services provided by both modules 18 and 22 when these modules 18 and 22 are used in combination with one another.

In the illustrated embodiment, the access panel 52 may include several hydraulic output couplings 52 as well as hydraulic and power controls to monitor and configure settings for service pack engine 14 and hydraulic pump 16. The access panel 52 may also permit, for example, starting and stopping of the service pack engine 14 by a keyed ignition or starter button. The access panel 52 may also include a stop, disconnect, or disable switch that allows the operator to prevent starting of the service pack engine 14, such as during transport. The access panel 52 may also include hydraulic pressure gauge 74, engine RPM gauge 76, engine fuel gauge 78, engine temperature gauge 80, and various inputs and outputs as generally depicted by numeral 82.

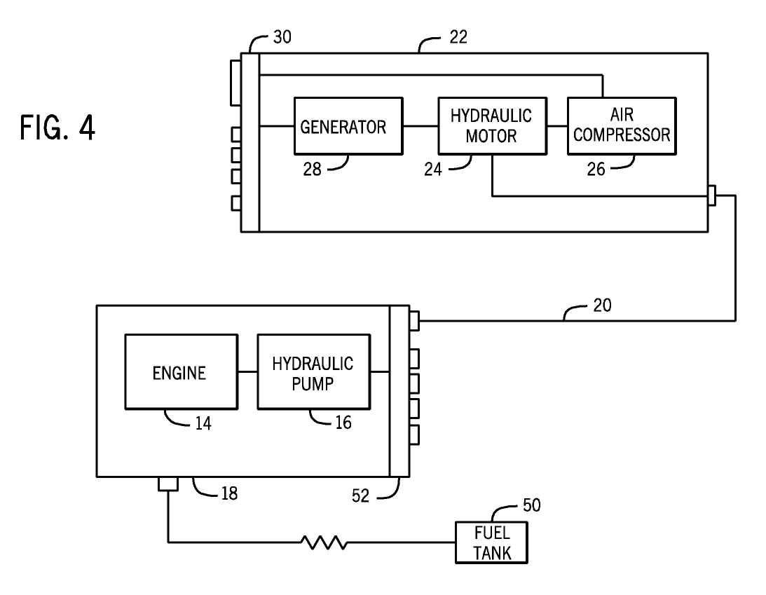

FIG. 4 depicts another embodiment of first service pack module 18 and second service pack module 22. As shown, first service pack module 18 includes service pack engine 14 as well as hydraulic pump 16. Fuel tank 50 is located outside the enclosure for first service pack module 18. In the present embodiment, fuel tank 50 may be shared with and used by vehicle engine 12. Alternatively, fuel tank 50 may be dedicated to service pack engine 14. In the present embodiment, first service pack module 18 is coupled to second service pack module 22 via hydraulic tubing 20. Second service pack module 22 includes generator 28, hydraulic motor 24, and air compressor 26. In certain embodiments, as illustrated in FIG. 4, the first service pack module 18 consists essentially of service pack engine 14 and hydraulic pump 16. In other words, in the present embodiment, the first service pack module 18 does not include fuel tank 50, the hydraulic motor 24, the air compressor 26, and the generator 28. Similarly, in certain embodiments as illustrated in FIG. 4, the second service pack module 22 consists essentially of generator 28, hydraulic motor 24, and air compressor 26. In other words, in the present embodiment, the second service pack module 22 excludes the engine 14 and the hydraulic pump 16 among other things.

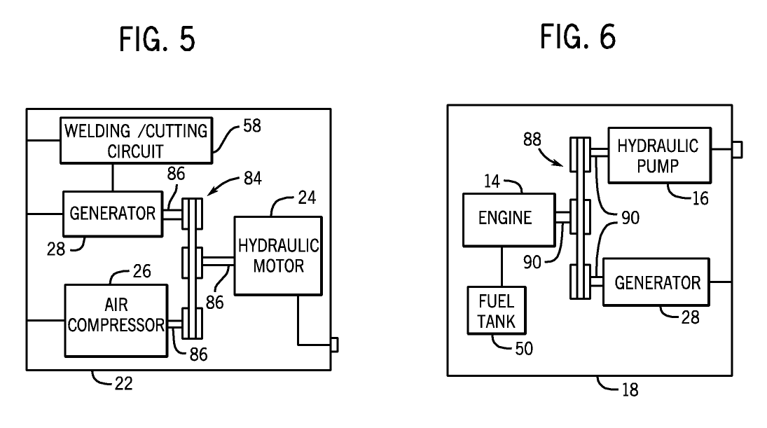

FIG. 5 shows an embodiment of second service pack module 22 which includes air compressor 26, generator 28, welding circuit 58, and hydraulic motor 24. In the illustrated embodiment, hydraulic motor 24 drives generator 28 and air compressor 26 via a belt drive system 84. Hydraulic motor 24, generator 28, and air compressor 26 may be connected to belt drive system 84 via drive connections 86. Drive connections 86 couple the components to the belt drive system 84 and may include shafts, pulleys, gears, clutches, or any combination thereof.

FIG. 6 is an illustration of an embodiment of first service pack module 18. First service pack module 18 includes service pack engine 14, generator 28, and hydraulic pump 16. In the present embodiment, service pack engine 14 is coupled to hydraulic pump 16 and generator 28 via belt drive system 88. Belt drive system 88 may be coupled to the components via drive connections 90. Drive connections 90 may include clutches, gears, shafts, pulleys, or any combination thereof. Also shown in the diagram is fuel tank 50, contained within first service pack module 18. In this particular embodiment, the first service pack module 18 may output hydraulic power as well as electric power. In certain embodiments, as illustrated in FIG. 6, the first service pack module 18 consists essentially of service pack engine 14, hydraulic pump 16, generator 28, fuel tank 50, and belt drive system 88. In other embodiments, the first service pack module 18 consists essentially of service pack engine 14, hydraulic pump 16, generator 28, and fuel tank 50. In further embodiments, the first service pack module 18 consists essentially of service pack engine 14, hydraulic pump 16, and generator 28 (e.g., without fuel tank 50).

Referring to FIGS. 5 and 6, one or more belts and/or clutches may be drivingly coupled between these components, and an idler may also be provided for maintaining tension on the belt. For example, a clutch (e.g., an electrically powered clutch) may be used to selectively engage and disengage any of the illustrated components to allow for separate control of the components. Such control may be useful for controlling the power draw on the engine and/or hydraulic motor, particularly when no load is drawn from the particular component. As may be contemplated, more than one belt may be provided on appropriate multi-belt pulleys, where the torque for turning the components is greater than that available from a single belt. Other arrangements, such as chain drives, are also be envisaged. Moreover, as described above, the generator 28 may be belt or chain driven, or more than one component may be driven directly by the hydraulic motor 24 or the service pack engine 14, such as in an in-line configuration. In a further alternative arrangement, one or more of the components may be gear driven, with gearing providing any required increase or decrease in rotational speed from the output speed of the engine. The particular component or components that are directly and/or indirectly driven by the hydraulic motor or engine may be selected based upon specifications.

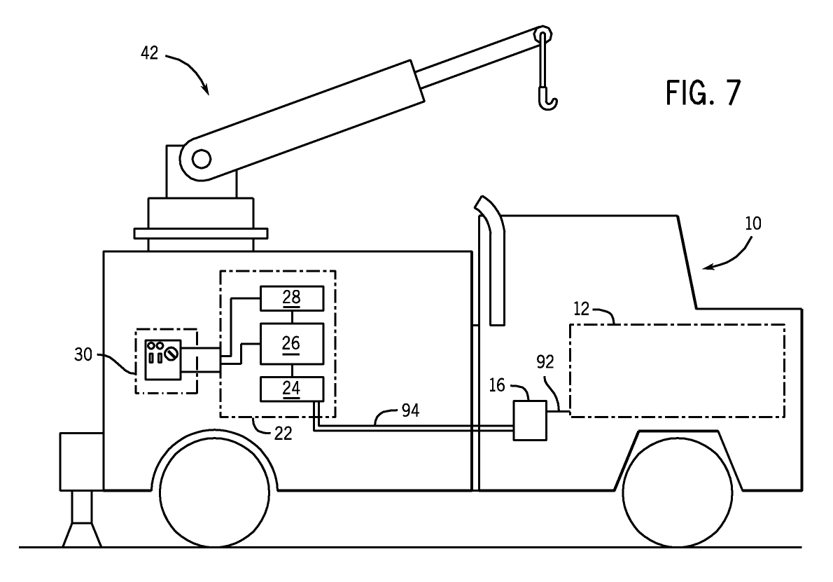

FIG. 7 is a block diagram illustrating an alternative configuration of service pack module 22 without service pack module 18 within the work vehicle 10. In the illustrated embodiment, the vehicle engine 12 directly drives hydraulic pump 16 via engine power take-off (PTO) shaft 92. A clutch or other selective engagement mechanism may be provided to enable the hydraulic pump 16 to be driven when desired and disengaged from the vehicle engine 12 when vehicle 10 is in transport to a work site. In the present embodiment, hydraulic pump 16 is connected via hydraulic tubing 94 to hydraulic motor 24, which is a component of second service pack module 22. Second service pack module 22 includes hydraulic motor 24, air compressor 26, and generator 28. As illustrated, second power module 22 receives hydraulic power from hydraulic pump 16, which is driven by vehicle engine 12, instead of a separate service pack engine, as shown in previous embodiments.

Several different scenarios are envisaged for arrangement of the components of the service pack modules 18 and 22, and for integrating or separating the support systems and components of the service pack modules from those of the vehicle 10. Thus, the elements contained in the modules discussed above may be added or removed, and/or rearranged, depending upon application-specific and other constraints. For example, second service pack module 22 of FIG. 2 may be combined with first service pack module 18 of FIG. 4 to deliver desired services on a work vehicle.

In some embodiments, which are not illustrated, some of the support systems for the vehicle engine 12 may be used to support the service pack engine 14, and vice-versa. For example, at least the fuel supply and electrical systems may be at least partially integrated to reduce the redundancy of these support systems in the work vehicle. The electrical system of the service pack modules may service certain support needs when the vehicle engine 12 is turned off, such as providing 12V power to vehicle accessories and charging the vehicle batteries. Similarly, heating, ventilating and air conditioning systems may be supported by the service pack engine 14, to provide heating of the vehicle cab when the vehicle engine 12 is turned off. Finally, a fuel conduit may draw fuel from the reservoir/tank of the vehicle engine 12 to supply fuel to the service pack engine 14. Further, more or less integration and removal of redundancy is possible.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a first enclosure;
a hydraulic motor;
an air compressor drivingly coupled to the hydraulic motor; and
a generator drivingly coupled to the hydraulic motor, wherein the hydraulic motor, the air compressor, and the generator are self-contained within the first enclosure without an engine and a hydraulic pump.

2. The system of claim 1, comprising a welding circuit coupled to the generator.

3. The system of claim 1, comprising a second enclosure having a hydraulic pump and a stand-alone fuel-powered engine, wherein the first and second enclosures are separate from one another.

4. The system of claim 3, wherein the hydraulic pump is configured to supply hydraulic fluid to the hydraulic motor.

5. The system of claim 3, wherein the first enclosure and second enclosure do not contain a fuel tank.

6. The system of claim 3, wherein the second enclosure comprises a fuel tank.

7. The system of claim 3, comprising a vehicle having a hydraulically driven crane, wherein the hydraulic pump is drivingly coupled to the hydraulically driven crane.

8. The system of claim 1, comprising power circuitry coupled to the generator and configured to provide DC output power and AC output power.

9. A system, comprising:
a first service pack module, consisting essentially of:
a hydraulic motor;
an air compressor drivingly coupled to the hydraulic motor;
a generator drivingly coupled to the hydraulic motor; and
a torch circuit coupled to the generator.

10. The system of claim 9, comprising a vehicle wherein the first service pack module is disposed in the vehicle, and the vehicle and the first service pack module share support systems with one another.

11. The system of claim 10, wherein the support systems comprise a control system, an electrical protection and distribution system of, or a combination thereof.

12. The system of claim 9, comprising a second service pack module consisting essentially of:
a hydraulic pump; and
a stand-alone fuel-powered engine;
wherein the first and second service pack modules are separate from one another.

13. The system of claim 9, wherein the torch circuit comprises a welding circuit, a plasma cutting circuit, or a combination thereof.

14. The system of claim 12, wherein the hydraulic pump is configured to supply hydraulic fluid to the hydraulic motor.

15. A system, comprising:
a service pack module, comprising:
a first enclosure;
a hydraulic pump; and
a fuel-powered engine drivingly coupled to the hydraulic pump, wherein the hydraulic pump and the engine are self-contained within the first enclosure as a stand-alone unit without a fuel tank.

16. The system of claim 15, comprising a vehicle wherein the first service pack module is disposed in the vehicle, and the vehicle and the first service pack module share support systems with one another.

17. The system of claim 16, wherein the support systems comprise a fuel system, a 12-volt electrical protection and distribution system, or a combination thereof.

18. The system of claim 15, wherein the service pack module comprises a generator drivingly coupled to the engine, and the generator is self-contained within the first enclosure.

19. The system of claim 15, wherein the first enclosure does not contain a hydraulic motor and an air compressor.

20. The system of claim 15, wherein the service pack module consists essentially of:
the first enclosure;
the hydraulic pump; and
the fuel-powered engine.

21. The system of claim 15, wherein the service pack module consists essentially of:
the first enclosure;
the hydraulic pump;
the fuel-powered engine; and
a generator drivingly coupled to the fuel-powered engine.

22. A system, comprising:
a first service pack module, comprising:
a hydraulic motor;
an air compressor drivingly coupled to the hydraulic motor; and
a generator drivingly coupled to the hydraulic motor; and
a second service pack module, comprising:
an engine; and
a hydraulic pump drivingly coupled to the engine;
wherein the first and second service pack modules are separate from one another, and the hydraulic pump is configured to supply hydraulic fluid to the hydraulic motor.

23. The system of claim 22, comprising a welding circuit, an induction heating circuit, a plasma cutting circuit, or a combination thereof, coupled to the generator.

24. The system of claim 22, comprising a vehicle having a hydraulically driven crane, wherein the hydraulic pump is drivingly coupled to the hydraulically driven crane.
